(19) United States
(12) Patent Application Publication
(10) Pub. No.: US 2015/0046286 A1
(43) Pub. Date: Feb. 12, 2015

(54) PRODUCT CONTENT LIFECYCLE AND PRODUCT FEATURES

(71) Applicants: Jens Erb, Karlsruhe (DE); Regina Griesinger, Heidelberg (DE); Florian Stallmann, Heidelberg (DE); Axel Stoller, Heidelberg (DE); Sven Lang, Bad Schoenborn (DE)

(72) Inventors: Jens Erb, Karlsruhe (DE); Regina Griesinger, Heidelberg (DE); Florian Stallmann, Heidelberg (DE); Axel Stoller, Heidelberg (DE); Sven Lang, Bad Schoenborn (DE)

(73) Assignee: SAP AG, Walldorf (DE)

(21) Appl. No.: 13/962,478

(22) Filed: Aug. 8, 2013

(51) Int. Cl. G06Q 30/06

(52) U.S. Cl. CPC G06Q 30/0623
USPC 705/26.61

(57) ABSTRACT

A holistic process is presented that may define a mature definition and management of product content over the entire lifecycle of the product. Product features may be used to describe business or technical details provided by functions for different releases of the product. The product features may be used to manage different product content types and provide links to additional information managed in various storage locations. The product features may be used to provide both transparency about the capabilities of the software product at a detailed level and a systematic way of documenting the relationship between the product features and related product content types such product documentation.

### BACKGROUND

Developing and maintaining a software product includes a variety of processes, activities, and tasks. The process of developing and maintaining the software product is known as the product lifecycle. Software vendors are facing the challenge of aligning the planning, development, production, and go-to-market of innovations over the entire lifecycle of their products.

Existing methods to develop and use product content do not provide adequate descriptions of the software product that can be used in different stages of the product lifecycle. For example, pure text based product documentation does not systematically describe the attributes and relationships of the product content in a way that can be used by the different departments of the software vendor over the lifecycle of the product. Because different departments of the software vendor use different terminology and define the product content and innovations differently, the pure text based product documentation makes it difficult to use the same documentation in all of the departments.

The lack of documentation that can be used over the product lifecycle also prevents the vendor from presenting the most relevant information to the customers. For example, the information supplied by the vendor to the customer based on existing documentation does not sufficiently represent the benefits of the upgrade to make the cost and risk associated with the upgrade seem worthwhile to the customer. Thus, customers are often hesitant to upgrade to new versions of the product or to activate and use the new functionality.

### BRIEF DESCRIPTION OF THE DRAWINGS

The accompanying drawings illustrate the various embodiments and, together with the description, further serve to explain the principles of the embodiments and to enable one skilled in the pertinent art to make and use the embodiments.

FIG. 1 illustrates a basic diagram of content associated with a product according to an embodiment of the present disclosure.

FIG. 2 illustrates a graph of product availability based on product content according to an embodiment of the present disclosure.

FIGS. 3A and 3B illustrate a product feature metamodel according to an embodiment of the present disclosure.

FIG. 4 illustrates a plurality of customer use cases in a product lifecycle according to an embodiment of the present disclosure.

FIG. 5 illustrates product content lifecycle phases and innovation lifecycle according to an embodiment of the present disclosure.

FIG. 6 is a block diagram of an exemplary computer system that may be used with the embodiments of the present disclosure.

### SUMMARY

Content may be created for a product having a plurality of releases. The content may include product features associated with the releases of the product and the product features may include attributes and relationships. The attributes of the product features may describe a business value and technical information associated with the product. The relationships of the product features may provide the relationship of the product features to other product content entities. The other product content entities may also include relationships to the product features. Tests may be performed on the product features and a status of the product features may be set to public. A list with the public product features may be released to customer interfaces supporting customer uses cases using the product features.

### DETAILED DESCRIPTION

Embodiments of the present disclosure provide methods to provide a holistic process that may define a mature definition and management of product content over the entire lifecycle of the product. Product features may be used to describe business or technical details provided by functions for different releases of the product. The product features may be used to manage different product content types and provide links to additional information managed in various storage locations. The product features may be used to provide both transparency about the capabilities of the software product at a detailed level and a systematic way of documenting the relationship between the product features and related product content types such product documentation.

The content of the product features may be leveraged to support various purposes and use cases around the discovery, planning, deployment and use of innovations in the lifecycle of the product. The product features may enable flexibility for the presentation layer to support positioning in the market and services such as detecting unused functionality based on customer usage analysis. The product features may be reused in the presentation layer by different development stages, may be browsed via a product feature catalogue, and may enable various business processes. These advantages may be achieved by creating and managing structured data for the product features. Unlike release notes and release presentations, which provide a purely descriptive approach within one product, the product features provide both transparency of the product's capabilities and document the relationship to other product content as well.

Thus, the customers of the product may be provided with a complete and structured insight into the innovations and product features provided by the product. These innovations and product features provide reference to specific versions of the product. Based on the product features made available by the software vendor, the customers may determine which of their business processes may be implemented or improved.

The product features may also allow for consistency between the different stages of the product content lifecycle. The product features may provide a transparent and comprehensive product content lifecycle process with complete and correct information provided on different levels. Thus, for example, no new developments may be forgotten to be positioned on the marketing level, and nothing may be positioned by marketing that was not developed. Such a structure may allow for customers and developers to seamlessly discover topics of interest, plan for implementation and deploy new solutions. Using the product features, the developers may define the product content as an integral part of the development process, and thus, avoid inconsistencies and multiple entries of the same information.

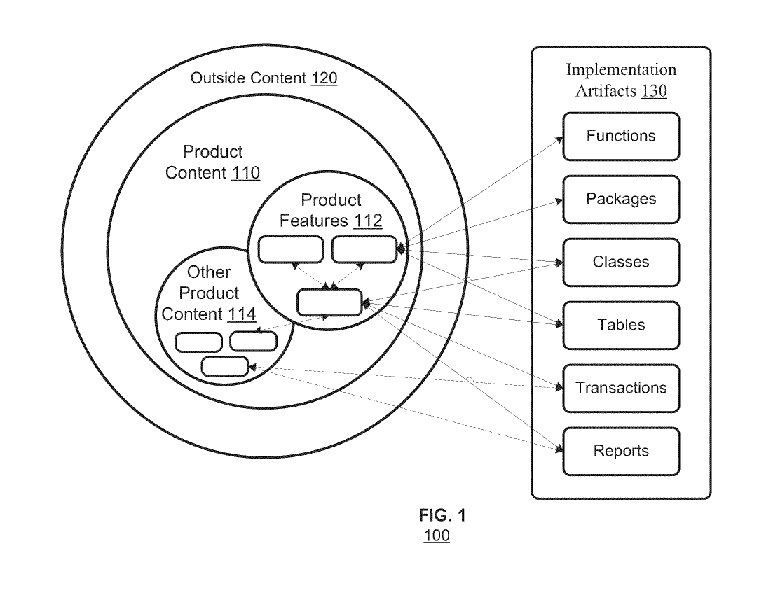

FIG. 1 illustrates a basic diagram of content 100 associated with a product according to an embodiment of the present disclosure. The content 100 associated with the product may include product content 110, outside content 120 and implementation artifacts 130. The product content 110 may include product features 112 and other product content 114. The product may be a software product.

The product content 110 includes information describing the product. The information may describe the functionality, the delivered value, and/or the prerequisites for using the product. The information describing the product may be provided as metadata (e.g., attribute values specifying the product) and/or as additional data (e.g., presentation and recorded product demonstrations).

The product features 112 are the central building block within the product content 110. The product features 112 may provide information about the capability of the software product and may describe the software product in detail that is arbitrarily fine-granular to be business relevant. The product features 112 may be materialized in a concrete set of implementation artifacts 130.

The purpose of the product features 112 may include providing transparency about the capabilities of the product. The product features 112 may provide information about capabilities of the product at different versions of the product. The information may be provided down to the lowest level of detail and granularity where a benefit or business value of the individual product features can still be stated. This information may include capability delta between two versions of the product (e.g., ability to perform additional tasks or function by a new version of the product).

The product features 112 may also provide a link between a business and technical view of the product. Each product feature 112 may point to implementation artifacts 130 of the product. The implementation artifacts 130, to which the product features 112 point, may be implementation artifacts 130 that are contributing to and/or are needed to be available to a particular product feature 112. The implementation artifacts 130 may include functions, packages, classes, tables, transactions and reports used by the product, but are not so limited. Each product feature 112 may be associated with a specific set of implementation artifacts 130.

The definition of the product features 112 may not be a technical decision but may primarily be driven by the desire to position the product to customers. Because the product features 112 may be associated with specific set of implementation artifacts 130, creating the link from the product features 112 to the implementation artifacts 130 may need sufficient technical expertise. The association of the product features 112 with the implementation artifacts 130 may provide the details needed to implement the features in a product. Thus, the product feature 112 may be created by a development team, may be created in alignment with a corresponding product manager, and may be used by users implementing the product.

Making the decision on a relevant product feature 112 may be based on an overview of all related product features 112. Because all of the related product features 112 of a new release may be available only at the end of the development, the list of product features 112 for new version of software components may be created towards the end of the development cycle for the release.

The other product content 114 may use the product features 112. The other product content 114 may also be referenced by the product features 112. Thus, the product feature 112 may directly link relevant information to the respective other product content 114 and other product features 112 and facilitate fast and comprehensive understanding of the software product. The other product content 114 may include business process descriptions, product and production management data, functional hierarchies, product documentation, and other documentation assets. The other product content 114 may be associated with and may use the product features 112. The other product content 114 and the product features 112 may be associated with a specific set of implementation artifacts 130.

The outside content 120 may include collateral material (e.g., marketing material). The outside content 120 may include information that is not part of the product content 110. The outside content 120 may be associated with the product features 112 and/or the other product content 114. The product content 110 may not be associated with outside content 120 though.

The product features 112 may be predominantly documentation entities with a defined set of attributes. The product features 112 may provide descriptions of the product to business users. The descriptions of the product may include detailed descriptions of the additional business scope provided by a specific version of a product. While the product features 112 do not describe specific technical details of deployable software components, the product features 112 describe a capability that is realized in concrete software components. The product features 112 may reference specific implementation artifacts 130 that realize them. Thus, product features 112 may exist at the interface between the business and technical worlds. The product features 112 may be used for marketing and positioning purposes. The marking and positioning purposes may call for flexibility to select the most effective presentation but still with a strict and systematic approach. While authors of product features 112 may have flexibility in the content and organization of the product features 112, the statements in the product features 112 may be based on the software components of a specific version of a product.

The association between the implementation artifacts 130 and the product features 112 may allow customers and consultants to transition between different phases of the adoption process (e.g., discover, requirement analysis, scoping deployment and configuration). For example, the association between the implementation artifacts and the product features 112 may allow easy transition from identifying the business scope during requirements analysis to a concrete set of products and deployment options that may be required to implement the identified business scope.

The product features 112 may be used for business semantics. For example, the product features 112 may be used for usage reporting to identify features that are being used by the customers. The reporting using the product features 112 may translate technical usage measurements into an analysis of the capabilities that were used.

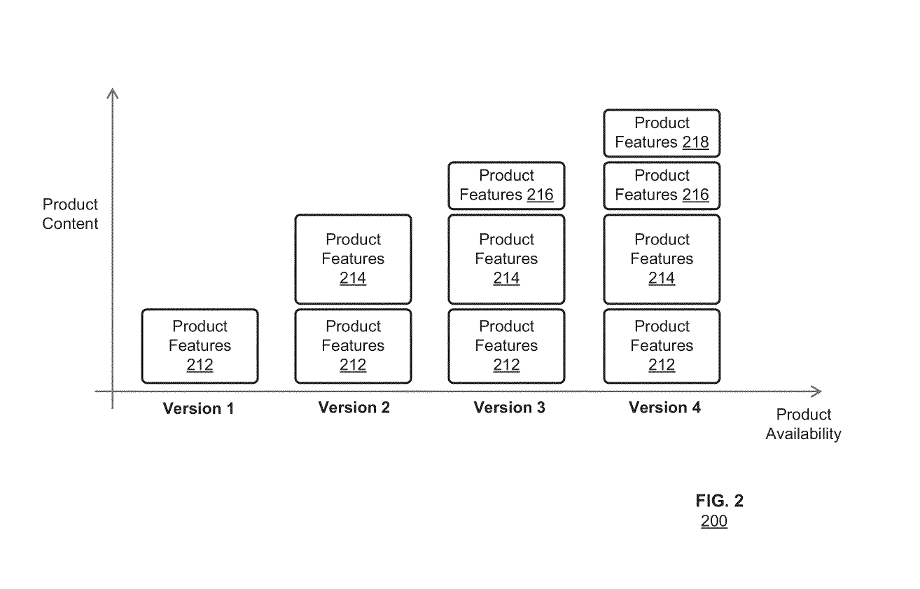

As discussed above, statements in the product features 112 may be based on the specific versions of the software components of a product. FIG. 2 illustrates a graph 200 of product availability based on product content according to an embodiment of the present disclosure. As shown in FIG. 2, different versions of the product or software component may provide different sets of product features 212-218. For example, version 1 of the product may include a set of product features 212. Version 3 of the product may include sets of product features 212, 214 and 216.

A new iteration, revision or version of a product may be defined by a true software component version (e.g., major version) or a support package for the software component (e.g., minor version). After a product feature is introduced (e.g., set of product features 212), with for example, a major or a minor version, it may remain stable (i.e., remain the same) with introduction of subsequent versions of the software component. The product feature may remain stable, provided that the underlying implementation in the product remains in place. Subsequent versions of the product may include additional product features (e.g., set of product features 218 in version 4) without changing previously provided product features (e.g., sets of product features 212, 214 and 216 in version 4). As shown in FIG. 2, the addition of product features in subsequent versions may increase the product content.

In the initial version (e.g., version 1) the product features are linked to exactly one version of the software product. The product features linked to the initial version may be valid for all subsequent versions (e.g., versions 2-4) implicitly. The product features linked to the initial version may not be valid for a subsequent version if the product feature is superseded by another product feature.

Because the product features may remain the same, there may be no revisions or different versions of the same product feature. If a revision is made to a product feature a new product feature is created. For example, if a particular user interface is introduced as product feature A, and the user interface is extended with additional fields or available actions, a new product feature B is created to represent these changes. Information may be provided to represent the relationship between product feature A and product feature B. The relationship may explain that product feature B extends product feature A. A subsequent product feature C may correct some important issues in product feature A. Thus, product feature C is an extension of product feature A. If the user interface is reimplemented, product feature D is created to describe the reimplementation of the user interface. Product feature D supersedes product feature A. With the reimplemented user interface, the product feature A may be deprecated and marked as obsolete. Product feature D may include information about the relationship of product features A, B C and/or D.

Using the product features may allow for the functional difference (e.g., delta) between multiple software component versions to be easily determined. Determining the functional difference between two software component versions may include collecting all product features released after the earlier versions. Determining the functional difference between two software component versions may include discounting obsolete product features. The functional difference between two product versions may be provided to customers considering an upgrade of the product. The functional difference between two product versions may be created based on the assignment of the product versions and software component versions in the construction plans of the products.

When a description of a product version is provided to a new customer, some of the information provided in the aggregated view may be hidden or modified. For example, a new customer may not need to know about the history of how different versions of the product were developed or which features were corrected. Thus, for the new customer, the implementation history and descriptions of product feature C, which was the correction, may be hidden. The description of product feature B, which was an extension of product feature A, may be integrated into the description of product feature A for a new customer. This information may still be provided for a customer using an older version of the product and who is considering an upgrade.

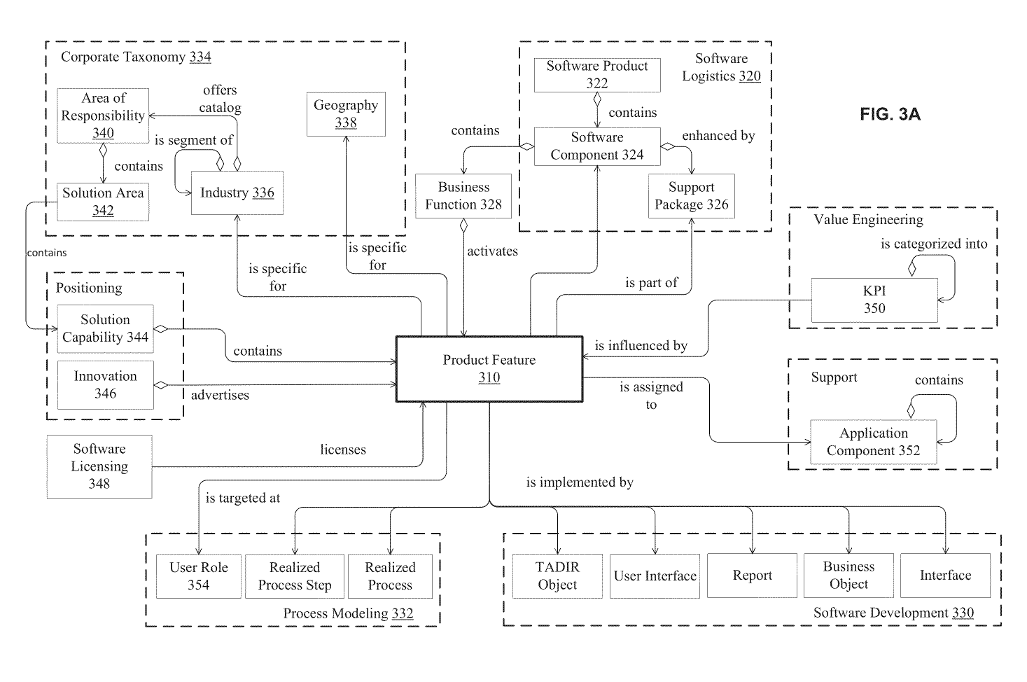

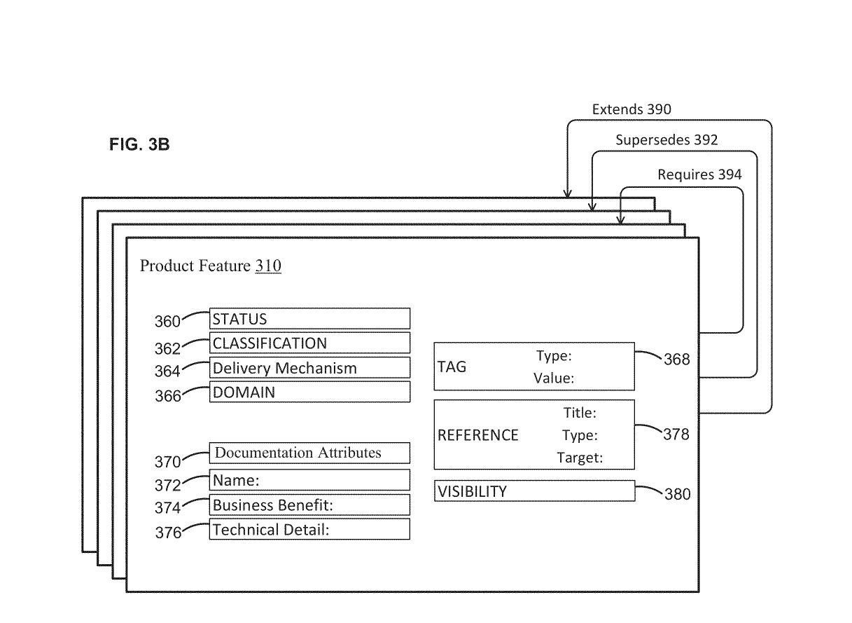

FIGS. 3A and 3B illustrate a product feature metamodel 300 according to an embodiment of the present disclosure. As illustrated in FIGS. 3A and 3B, the metamodel includes a plurality of relationships and attributes of the product feature 310. The metamodel 300 of each product feature may be created during the product content lifecycle.

As shown in FIG. 3A, the product feature 310 is associated with software logistics 320. As part of the software logistics, a software product 322 includes one or more software components 324 which may be enhanced by support packages 326. The software components may include a plurality of business functions 328. Each product feature 310 may be assigned as part of a specific version of the software component 324 and/or a specific support package 326. The product feature 310 may have a derived relationship to the software product 322 via the software component 324. The relationship of the product feature 310 to the software product 322 may be computed based on the relationship between the product feature 310 and the software component version 324.

As discussed above, the product feature 310 may be linked to implementation artifacts of the product that implement the product feature 310. The implementation artifacts referenced by the product feature 310 may be part of the software development 330 or the process modeling 332. The implementation artifacts in the software development 330 may include object directories, user interfaces, reports, business objects and/or interfaces. The implementation artifacts in the process modeling 332 may include realized process steps and realized processes. The documentation of the product feature 310 may be sufficient to determine what implementation artifacts to deploy, to examine or switch on in order to use the product feature. The documentation may not need to have a level of technical detail that is needed by a developer.

The product feature 310 may reference specific implementation artifacts. How the implementation artifact is referenced may depend on the type of implementation artifact being referenced. For example, Advanced Business Application Programming (ABAP) developed objects may be referenced through the available infrastructure, as the object directory provides a central repository covering most relevant object types. For non-ABAP objects, decisions may be made on how to specifically reference and model the non-ABAP objects. Entities having a model representation (e.g., Solution Manager or a Metadata Repository) may be referenced in the model. The targets in the product feature 310 may be provided on a high level and/or on a technical level. The targets on the high level may include transactions, reports, service interfaces, business objects, and/or process steps. The targets on the technical level may include switches, packages, classes, tables, table fields, screens, screen fields, user interface components, modules, functions, enhancement points, and/or business add ins (BADIs). The product feature 310 may also be related to configuration data. For example, the configuration data may be a new code list or a fixed domain entry for a new document type that triggers the new way of processing a case the product feature 310 is introducing.

The product feature 310 may be associated with an application component hierarchy 352. Every product feature 310 may be assigned to an application component from the application component hierarchy 352. This relationship may be derived as each product feature 310 may be assigned to a software component 324 and each software component 324 may be assigned to an application component 352. If the software component 324 is large, the product feature 310 may be assigned to more precise application components 352. Such a structure may enable building an alternative feature catalog with a structure that is determined by an organization's (e.g., SAP® internal organization and not based on externally imposed, potentially less stable, solution view.

The product feature 310 may be associated with one or more classifications in corporate taxonomy 334. As shown in FIG. 3A, the product feature may be industry 336 and/or geography 338 specific. For example, each product feature 310 may be specific to one or more industries 336 or industry segments. This relationship between the product feature 310 and the industry 336 may be used by product features owned by industry development. The industry 336 may offer catalogs with areas of responsibility 340. A solution area 342 may be included with solutions for various areas of responsibility 340.

Similarly, each product feature 320 may be specific to one or more geographic classifications 338. The geography classification 338 may include cities, states, countries and/or regions, but are not so limited. The relationship of the product feature 320 to the geographic classification 338 may be used by product features from a globalization layer.

The product feature 310 may be associated with a targeted user role 354. The product feature 310 may be targeted to a specific type of user. For example, the product feature may 310 be targeted for administrators specified in the user role 354. The product feature 310 may hold a reference to the corresponding user role 354. The reference may be directly stored in the product feature 310 or in a user role object in the metadata repository.

The product feature 310 may reference other entities. In one embodiment, the product feature 310 does not reference entities that exist on a higher, more abstract level or entities that are inherently less stable than the product feature 310. The reference may point from more volatile to more constant or more basic entities at the level of the data model. Thus, the disappearance of a volatile object instance does not put the stable object into an inconsistent state. This is insured by a default setting where the link between the two objects is part of the object that is being discarded. In some applications (e.g., in a consumption user interface), there is no difference as to how the objects are linked. The application tools in these applications turn the direction of the linked objects.

A number of entities may reference product features 310 in an attempt to make their own functional scope more concrete. These entities may include solution capabilities 344, innovations 346, business functions 328, software licensing 348, key performance indicators (KPIs) 350, and backlog items.

The solution capabilities 344 define a list of product features that correspond to functional scope of the solution capabilities 344. Because the solution capabilities 344 may need to evolve with customer expectations, the product feature 310 may be more stable than the solution capabilities 344. However, due to technical feasibility and content maintenance process driven considerations, the product features 310 points to the solution capability 344.

Many of the considerations for the product feature 310 may be relevant for the innovation 346. These considerations may be relevant for the innovation 346 at a less detailed level as compared to the product feature 310. The innovation 346 may use the product feature 310 to make the scope of the innovation 346 more concrete. The product feature's link to the implementation may provide the innovation 346 with the association which may be used to answer how a customer may put the advertised innovation 346 to work. The link between the innovation 346 and the product feature 310 may point from the product feature 310 to the innovation 346. The link may be provided from the innovation 346 to the product feature 310 after the product feature 310 is created.

The business function 328 may comprise its list of product features 310 and provide them for the use by activating the appropriate switches. Not every product feature 310 may be tied to a business function 328. Some products, for example add-ons, may not need or use a business function.

The software licensing 348 may provide information as to which product features 310 can be used or should be used. In one embodiment, the software licensing material 348 may require the use of certain product features 310 or limit which product 310 may be available. The software licensing material 348 may be specific to particular users and/or organizations. Thus, certain product features may not be displayed or made available to users if they are not licensed in the software licensing material 348. In one embodiment, a user may be displayed which licensees may be required to use selected product features 310 associated with specific version of the product. The functional scope of the software licensing 348 may be made more concrete by assigning a list of product features 310. If the referenced product feature 310 is grouped according to some criterion that is not general (e.g., addressable by tags) but is specific to the software licensing 348, the relationship may be tagged from the software licensing 348 to the product feature 310 with a group label (i.e., context-specific grouping).

The Key Performance Indicator (KPI) may reference specific product features 310. Value engineering may define a KPI that is designed to measure the performance of a specific product feature 310. Tracking the product feature 310 may also be performed by referencing the product feature from backlog items.

FIG. 3B illustrates attributes of the product feature 310 and the relationship of the product feature to other product features. The structured data for the product features 310 may provide transparency of the products capabilities and/or document the relationship to other product content. The attributes may include status 360, classification 362, delivery mechanism 364, domain 366, tags 368, document attributes 370, name attribute 372, business benefit 374, technical detail 376, reference 378, and visibility 380. One or more of these attributes may be mandatory for all of the product features. Which attributes are mandatory may be based on the type of product feature, the type of product for which the product future is used, and/or whether the product feature is associated with a software component or a support package.

The status 360 of the product feature 310 may indicate the standing of the product feature 310 for one or more versions of the software component 324. The status 360 may be release dependent. Where the same product feature 310 exists across different versions of the software component 324, a different status 360 is provided for each version. The status 360 may include planned, in development, released, deprecated, obsolete, and superseded. Planned status may indicate that the release of a product feature 310 is being postponed. Superseded status may indicate that a product feature 310 has been replaced. Each possible status 360 may be maintained separately with a reference to when the version of the software component 324 was first valid.

The classification 362 may provide the role of the product feature 310. The classification 362 of the product feature 310 may include original, delta and correction classification. A product feature 310 that extends the business scope of the product with a new capability is classified as an original feature. The original classification may indicate that the product feature 310 is not merely an extension of an existing feature. A product feature 310 that enhances another product feature is classified as a delta feature. In an aggregated view, the product feature 310 classified as an enhanced feature is subsumed into the product feature it is enhancing. A product feature 310 that only contributes a technical fix is classified as a correction feature. A product feature 310 that is classified as a correction feature does not introduce new functionality.

The delivery mechanism 364 may provide how the product feature 310 is delivered. The default value of the delivery mechanism 364 may be determined by the version of the software component 324. The default value of the delivery mechanism 364 may be manually changed. The product feature 310 may be delivered via a new version, as part of an enhancement that is controlled via a business function, or as part of an add-on.

The domain 366 may provide the type of capabilities the product feature 310 provides. The domain 366 may characterize the product features 310 based on the types of implementation artifacts the product feature 310 are referencing. The domain 366 of the product feature 310 may be functional. Functional domain may be the default domain category of product feature. The domain 366 of a product feature 310 may be set to user interface or report, if the product feature 310 provides a new user interface or report, respectively. The domain 366 of the product feature 310 may bet set to activities, if the product feature 310 provides new activities that may correspond to the functional scope of a realized process step. The domain 366 of a product feature 310 may be a processing type if the product features provide a new behavior or behavior variant. The domain 366 of a product feature 310 may be non-functional if the product feature 310 is dealing with topics such as performance, security or consistency.

The tags 368 may provide an extension mechanism that allows defining additional classifications to the product feature 310. The tags 368 may be used to include additional categories that are not properly represented by a standard element of the corporate taxonomy 334. The tags 368 may be used, in some cases along with other classifications, for searching and filtering of product features 310.

The tags 368 may be used to impose alternative catalog structures on a set of product features 310. The alternative catalog structures may be used to introduce a minimum amount of structure into the presentation of product features 310. The tags 368 may allow presenting the product features based on use cases. The product features 310 may be tagged with the use case as the tag type, and the group label as the tag value. This structure may provide one or more levels of hierarchical groups. As the primary use case for the produce features 310 may be to display the difference between versions for a specific context (e.g., a solution capability), providing an ordered overall catalog of all product features may not be particularly important.

The product feature 310 may include a number of documentation attributes 370. As the product features 310 may help with positioning and documenting new enhancements, the documentation attributes 370 may provide appropriate content that is presented to customers. Each product feature 310 may have one or more mandatory textual attributes.

The name attribute 372 may be governed by a naming convention for the product feature 310. In one embodiment, two names may be used for the name attribute 372. A first name may be a short name that is, for example, easily pronounceable or catchy. The first name may not be unique. A second name may be a qualified name that takes the context of the product feature 310 into account. The first and the second names may be identical.

The business benefit 374 may provide a text that explains business benefits to the customer. The text may be based on a standardized template. The business benefit 374 may be a relevant business benefit provided by the product feature 310.

The technical detail 376 may provide a text that explains technical detail to the customer. The text may be based on a standardized template. The technical detail 376 may be a relevant technical detail provided by the product feature 310.

The reference attribute 378 may provide references to other asserts. The reference attribute 378 may be used to augment the product feature 310 with one or more informative references to other assets (e.g., targets). Each reference may include a link text, a target and a target type. Target types may include demos, release notes, knowledge transfer material, or application help. One or more of the references may be made mandatory.

The visibility attribute 380 may control the visibility of the product feature 310. The visibility attribute 380 may be used to hide product feature that are useful internally but which may not need to be display to a customer in a list of product features 310. Thus, the visibility attribute 380 may control the publication status of the product feature 310 (e.g., setting the status of the product feature 310 to public). The visibility attribute 380 may be used to control the visibility of technical product features which may not need to be displayed to certain users. The visibility attribute 380 may also be used to provide the customer a more focused list of product features while hiding some of the product features. Based on the visibility attribute 380, a list of product features with the status set to visible may be provided to a customer (e.g., customer interface supporting a plurality of customer use cases).

As shown in FIG. 3B the product feature 310 may have one or more relationships to other product features 310. For example, one product feature B may extend 390 another product feature A. When product feature B extends 390 product feature A, the functional scope of product feature B is more limited and logically a part of product feature A.

A product feature 310 may supersede 392 another product feature 310. When a new product feature supersedes 392 an existing produce feature, the new product feature takes the place of the existing product feature. The new product feature may take the place of the existing product feature in all new deployments. The new product feature may supersede the existing product feature when the new product feature is an incompatible reimplementation of the existing product feature rather than an extension.

To be usable in an operative system landscape (or installation), a product feature 310 may require 394 another product feature 310 as a prerequisite. In one embodiment, a full logical expression language is used to describe complex cases involving different alternatives requiring one or more product features. In another embodiment, a simple linear relationship pointing to the prerequisite is used. The relationship to other product features may include support for negative prerequisites (i.e., product features that are required to be not deployed). The negative prerequisites may be defined by flagging the required relationship 394 as negative or a dedicated relationship.

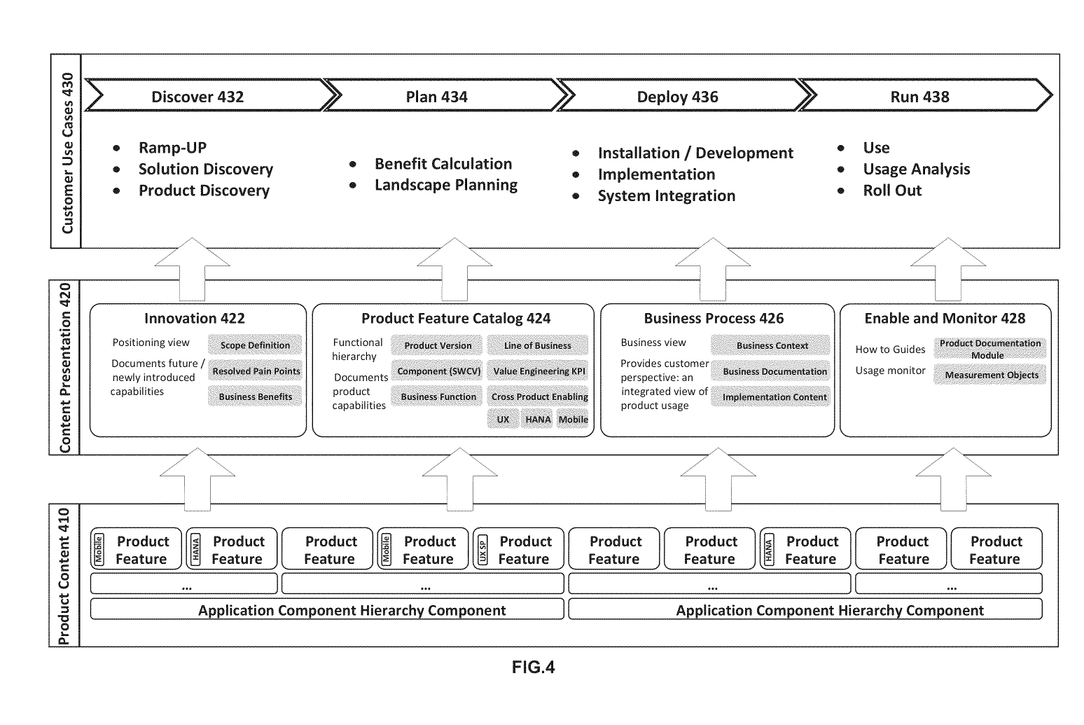

FIG. 4 illustrates a plurality of customer use cases in a product lifecycle according to an embodiment of the present disclosure. As shown in FIG. 4, the product content 410 are presented using various content presentations 420 which are used for a plurality of customer use cases 430. The product content 410 may include product features 412 which may be defined to support numerous customer uses cases 430.

The content presentations may include innovation 422, product feature catalog 424, business process 426 and enable and monitor 428 presentations. The innovation presentation 422 may highlight key product feature in the product content 410. The innovation presentation 422 may provide positioning view and documents/bundles planned and already delivered capabilities. The product feature catalog 424 may provide all product features in the product content 410. The product feature catalog 424 may provide a functional hierarchy and document product capabilities for the different versions of the product. The business process presentation 426 may assign product features which are required for certain implementations, deployments, or system integrations. The enable and monitor presentation 428 may create and fill document structures based on the product features in the product content 410. The enable and monitor presentation 428 may be used to provide how to guides and perform usage monitoring.

The customer use cases 430 may include discover 432, plan 434, deploy 436 and run 438. The discovery 432 may be based on the innovation presentation 422. The discovery 432 may include discover for a ramp-up, solution discovery and/or product discovery. The discovery 432 may provide what is new or what is not used but could be used based on the product features. The discovery 432 may include delta discovery, where the delta (e.g., capabilities delta) between releases of the product is displayed based on the product features. The delta between the releases of the product may be provided at the level of the entire product or an add-on or for a specific solution capability or business process. The discovery 432 may also include scope discovery to provide an aggregated scope (e.g., capability) for a product or solution capability. The scope discovery may display what is available without displaying the change history. The scope discovery may be used as a default display for new customers. The product features in the product content 410 used in the discovery 432 may provide the needed detail and link to realize an implementation of the software.

The planning 434 may be based on the product feature catalog 424. The planning 434 may include benefit calculation and/or landscape planning. The benefit calculation may include cost benefit analysis to estimate the benefits and necessary effort (e.g., in terms of landscape). The planning 434 may be based on the usage analysis of previous versions or releases performed in the usage analysis of the program running 438.

The deployment 436 may be based on the business process presentation 426. The deployment 436 may include installation, development, implementation and/or system integration. In the deployment 436, the product features may help to decide which parts of the product need to be deployed and/or activated (e.g., via business functions). In the long term, the product features may be used to activate functionality of the product directly (e.g., via the underlying switches). In the implementation of the business processes, the deployed product features may help to determine which variants can be supported. The determination may be made via direct constraints or by the product features when the process steps are represented by the product features.

The running 438 may be based on the enable and monitor presentation 428. The running 438 use case may include using the product, performing usage analysis and/or rolling out the product or enhancement package. Product features may be used when the product is being used according to the product related use cases. The product features may allow the customer to create and roll out easy to understand documentation for new functionality in the product. The product features may enable the user to perform specific actions in a desired way and/or measure the usage of the product on a detailed level.

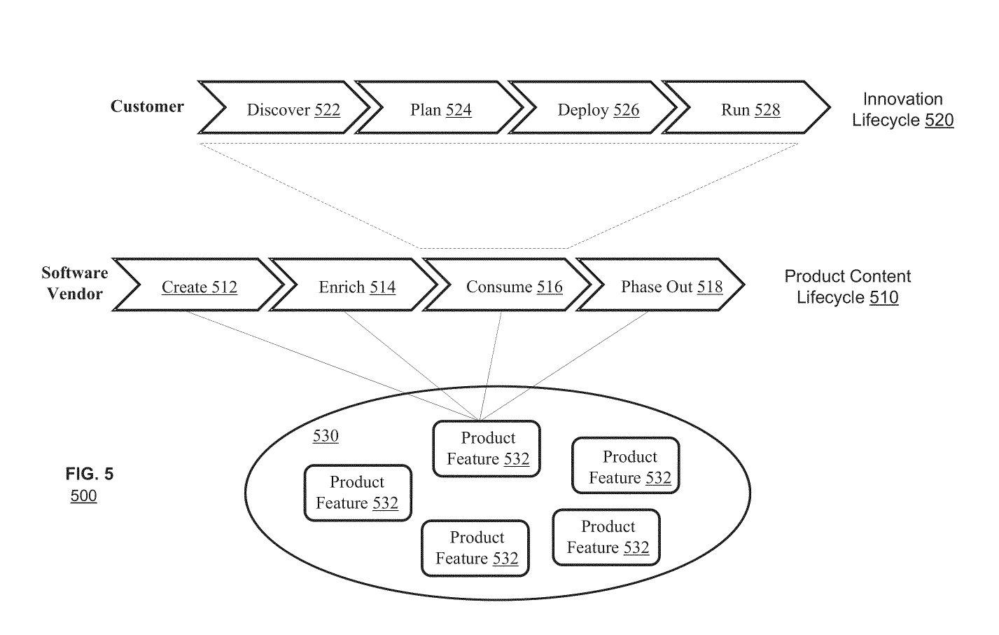

FIG. 5 illustrates product content lifecycle phases and innovation lifecycle according to an embodiment of the present disclosure. The product content lifecycle 510 may include create phase 512, enrich phase 514, consume phase 516 and phase out phase 518. The innovation lifecycle 520 may include discovery phase 522, plan phase 524, deploy phase 526 and run phase 528. The phases of the innovation lifecycle 520 may correspond to the customer uses cases 430, illustrated in FIG. 4. The product content lifecycle 510 may be related to the innovation lifecycle 520. The phases of the product content lifecycle 510 and/or innovation lifecycle 520 may be based on product feature 532. The product features 532 may be stored in a database 530. The product content lifecycle 510 may be managed by a product content management system.

The product content lifecycle 510 may provide for a holistic process for creating, enhancing, consuming and phasing out of product features 532. The product content lifecycle 510 may consider the product feature 532 from the start to the end of the lifecycle. The considerations may be made from the perspective of any user (e.g., from a software vendor or software customer perspective) combining the different perspectives.

The product content lifecycle 510 concepts may be related to the object product feature 532 and may define the lifecycle of the product feature 532. Being defined on such granular level for all developed software products may ensure consistency of information. The product feature 532 may provide a link to the technical information (e.g., implementation level) and may be maintained over the entire product content lifecycle 510 by all relevant departments (e.g., development, solutions and documentation departments).

Creation Phase

The creation phase 512 may create the product content in response to a request. The product content may include product features 532, lists of product features, product documentation and/or release notes. The list of product feature may be used to provide the structure of the product content.

The product content creation may be controlled by product development teams as standard deliverables aligned with the respective product development process phases. The list of product features 532 may be created early in the innovation lifecycle (e.g., at the end of the planning phase). The product feature 532 may be linked to a software component version determining the product versions(s) with which the product feature 532 will be made available. A determination may be made to determine which product features 532 are associated with each release of the product.

The product features 532 may also be used to create the product documentation describing new functionality. The product documentation may provide additional details about the functionality of the product features 532. These details in the product documentation may provide information that is in addition to the information supplied by the product features 532. For each product feature 532 a link may be created to the corresponding product documentation. The link may allow to drill down from the product feature 532 to the detailed description.

The list of product features 532 may be used to create the release notes for the corresponding products. Each release of the product may include a separate list of product features 532. Alternatively, the list may include a list of versions with which each product feature 532 is associated.

The attributes (e.g., attributes shown in FIG. 3B) of the product features 532 may be generated based on the data (e.g., implementation artifacts) associated with the product features 532. The attributes may be described by the responsible product teams. In one embodiment, the product owner describes the attributes of the product features 532. The attributes may be described during the creation 512 of the product feature. Business benefit related attributes of the product features 532 may be filled by a corresponding expert in a solution management organization. A tight integration of the product features 532 to the documentation environment may provide a seamless integration of documentation assets, which may allow to high quality and reuse of the product content.

The authors of the product content may need to be aware of the purpose for the provided content and why it is presented to the customers. The product content may be created based on which attributes are always displayed and which attributes may be hidden or displayed temporarily. The product content may also be created based on which attributes are displayed in the context of other attributes or if the attributes need to be self-explanatory.

Enriching Phase

The enriching phase 514 may include creating additional information for the product feature 532, updating the information in the product feature 532, associating the created product features 532 with additional content and performing a test and review process. The additional content may be stored in the database 530.

The database 530 storing the product features 532 may store the product features 532 in tables. The tables may store the product features 532 in lists of product features 532 and may also store related metadata, attributes and/or links. The metadata, attributes and/or links of the product features may be entered or updated in the enriching phase 514.

The lists of product features 532 may be sorted and/or filtered according to the available attributes. For example, the product features 532 may be filtered according to the software component version and/or the type of classification of the product feature 532.

The database 530 may store links to additional assets (e.g., presentations, screenshots) that are associated with the product features 532. The links may indicate whether the assets are optional or required to describe the product features. The additional assets may be stored in database 530 or stored in a different database or content management system (not shown in FIG. 5).

The product features 532 may be linked to the additional assets based on the meta model of the product features 532. As discussed above with reference to FIG. 3A, there are two type of possible relationships. In the first type of relationship, the entities may refer to product features 532. In the second type of relationship, the entities may be referenced by the product features 532.

Entities that refer to the product features 532 may allow for reuse of product features 532 within other content entities. This relationship type may be used for content entities that are either changed in higher frequency compared to the product feature 532 or content entities that are defined later in the lifecycle of the product (e.g., after the product features 532 are created). These entities may include areas of responsibility, solution areas and solution capabilities discussed in FIG. 3A. For example, solution capability A may reference product feature 1. When the solution capability A is replaced by solution capability B, solution capability B may now reference the same product feature 1.

In the second type of relationships, the product feature 532 may be provided with additional data and/or descriptions. The additional data and/or descriptions may be used to detail the definition of the product feature 532. The additional data and/or descriptions may be needed by one or more of the phases in the innovation lifecycle 520. For example, a software component version may be needed to determine the product version that should be installed for usage of a respective product feature 532. Thus, the product feature 532 may reference the software component version.

The product content management system may reference the content that is in other repositories, instead of duplicating the content into the product feature 532. The product content management system may also define value lists for attributes where adequate. Referencing content in other repositories and/or defining the value lists may provide consistency between the product features 532 including the references to related entities.

The product content management system may analyze the impact due to changes in the entities referenced by the product features 532. The product content management system may perform the analysis by identifying product features 532 with referenced entities that have changes. The product feature 532 may include rules for the management of changes to the product features 532 due to the changes in the referenced entities. The rules may control whether a new revision of an existing product feature 532 is created or not. The rules may include:
if instance “a” of a referenced entity is modified, creating a new revision for the product feature;
if instance “a” is replaced by instance “b” where both instances are semantically the same, not revising the product feature;
if instance “a” and instance “b” will be combined to form instance “c”, creating a new revision for the product feature;
if instance “a” is split into instance “a1” and instance “a2”, a new revision is created for the product feature; and
if instance “a” may be dropped without replacement, instance “a” is not allowed to be assigned to any product feature.

The product feature 532 may be updated by creating revisions of the product feature instance. The product feature 532 itself may not have a version attribute assigned, as it may be created for one software component version. In one embodiment, no new product features versions with significant new content may be allowed. The revisions may provide for content corrections but not for a changes in the scope of the product feature 532. In another embodiment, no new product feature 532 with any new content may be allowed. If a product feature 532 is extended, a new product feature may be created describing the difference between the first product feature and the product feature providing the extension.

As new product features 532 are created, the product feature repository may grow with each product release. New releases of the product may continue to support the product features 532 of previous releases. The new releases may add new product content that is demonstrated in additional product features 532.

Before a product feature is published, a test and review process may be performed. The test and review process may include ensuring that the product feature 532 meets certain criteria. For example, the test and review process may include checking for completeness of the product feature data. The test and review may be performed automatically by the system. A notification may be provided if the product feature 532 does not meet the predefined criteria or after the product feature 532 meets the minimum requirements defined by the test and review process. The test and review may include a manual review process performed by an experienced knowledge managing editor. The manual review process may include reviewing all text entered as part of the description of the product feature 532. The test may be performed on a list of product features set to be released.

Each product feature 532 may include a publishing attribute. The publishing attribute may control publication (e.g., visibility) of the product feature 532. The publishing attribute may include values “yes” and “no.” The default publishing attribute may be set to “no.” The publishing attribute may be controlled by the product owner. The product feature 532 may be published if certain predefined conditions are satisfied. The conditions may include whether the publishing attribute is set to yes (e.g., visibility set to show the product feature) and/or the product version related to the software component version has been released. Publishing the product feature may display the product feature to the customer and/or make the product feature available for implementation. Publishing the product feature 532 may be based on whether the version of the product with which the product feature is associated with is released.

Consumption Phase

The consumption phase 516 may include providing the product features to be used in one or more phases of the innovation lifecycle 520. As discussed above, the product features may be designed to support various use cases (e.g., use cases shown in FIG. 4). To support these uses cases, entities such as innovation and business process may reference the product features. Links may be provided between these entities and the product features 532.

The innovation may be used for positioning of new developments on a software product in the market. The innovation may include links to product features 532 that define what was developed. Similarly, a business process that a customer selects from a standard process repository for the implementation in his environment, may define links from the process step to the product features 532. The product features 532 may specify the software enhancements that support the additional process steps.

The consumption phase 516 may include accessing a list of the product features and filtering the product features according to the needs of the users (e.g., customers or developers). All of the product content that is stable and/or defined in the product features 532 may be aggregated and provided to the user. The user may make decisions and/or selections based on the aggregated data. The aggregated data may provide a summary of the enhancements that were delivered in an area selected by the user. The selected area may be a topic (e.g., financial accounting) or a defined time frame.

A catalogue application may allow for flexible access to the overall list of product features, enabling customers to filter according to their needs using the provided product feature attributes (e.g., attributes discussed with reference to FIGS. 3A and 3B). The software vendor may position the product features 532 or groups of product features 532 supporting the go to market strategy of the product not only for the initial release but also for the later releases. The listing of the product features may include product features that are relevant for the positioning using the product feature attributes.

The system may allow for the customer to be provided with new product features 532 for the most recent product release and with product features 532 for older versions. The customer may need the product features 532 for the older versions if the customer is using older software versions. The product features may be filtered based on when the product feature was first released, as the product features may remain valid for a specific product from the initial publication. The system may provide the user with product features that form the delta between different releases of the product. For example, in FIG. 2, product feature 218 may form the delta between release 3 and release 4.

The product features 532 that are selected by a user for implementation may be used to support the implementation of the product. The implementation may be based on the links in the product features 532 or in other entities to implement product with the selected product features. The product features 532 may be provided with specific access to the implementation information, configuration transactions and/or execution relevant data.

If the product features 532 are implemented in the software architecture itself, the product features 532 may be used to measure which product features have been used, how often the product features 532 have been used and by which user groups the product features 532 have been used.

Phase Out Phase

In the phase out phase 518 the product features may be used to remove certain functionalities from the market. The product feature 532 may exist as long as the respective functionality of a software product is offered on the market. A product feature 532 may be phased out (e.g., set status to deprecated) when the respective functionally needs to be removed from the market. A product feature 532 may be phased out when a new product feature supersedes the product feature 532 with the same or bigger functional scope. A product feature 532 may be phased out for technical reasons. For example, major updates, changed scope or major corrections in the product feature 532 may create a new product feature 532 and phase out a previous product feature 532. A product feature 532 may be deprecated for specific versions of the product while maintained active for other versions of the product.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits ‘ASICs’), programmable logic devices (“PLDs”) and ROM and RAM devices. Examples of computer readable instructions include machine code, such as produced by a compiler, and files containing higher-level code that are executed by a computer using an interpreter. For example, an embodiment of the disclosure may be implemented using Java, C++, or other object-oriented programming language and development tools. Another embodiment of the disclosure may be implemented in hard-wired circuitry in place of, or in combination with machine readable software instructions.

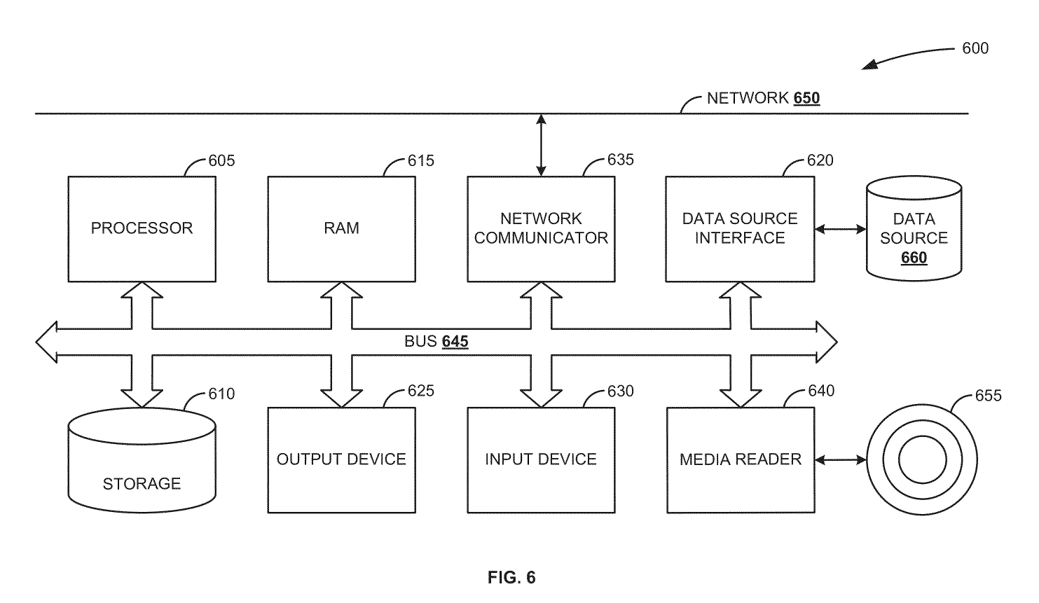

FIG. 6 is a block diagram of an exemplary computer system 600. The computer system 600 includes a processor 605 that executes software instructions or code stored on a computer readable storage medium 655 to perform the above-illustrated embodiments of the disclosure. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the disclosure, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

A semantic layer is an abstraction overlying one or more data sources. It removes the need for a user to master the various subtleties of existing query languages when writing queries. The provided abstraction includes metadata description of the data sources. The metadata can include terms meaningful for a user in place of the logical or physical descriptions used by the data source. For example, common business terms in place of table and column names. These terms can be localized and or domain specific. The layer may include logic associated with the underlying data allowing it to automatically formulate queries for execution against the underlying data sources. The logic includes connection to, structure for, and aspects of the data sources. Some semantic layers can be published, so that it can be shared by many clients and users. Some semantic layers implement security at a granularity corresponding to the underlying data sources' structure or at the semantic layer. The specific forms of semantic layers includes data model objects that describe the underlying data source and define dimensions, attributes and measures with the underlying data. The objects can represent relationships between dimension members, provides calculations associated with the underlying data.

In the above description, numerous specific details are set forth to provide a thorough understanding of embodiments of the disclosure. One skilled in the relevant art will recognize, however that the various embodiments can be practiced without one or more of the specific details or with other methods, components, techniques, etc. In other instances, well-known operations or structures are not shown or described in detail to avoid obscuring aspects of the disclosure.

Although the processes illustrated and described herein include series of steps, it will be appreciated that the different embodiments of the present disclosure are not limited by the illustrated ordering of steps, as some steps may occur in different orders, some concurrently with other steps apart from that shown and described herein. In addition, not all illustrated steps may be required to implement a methodology in accordance with the present disclosure. Moreover, it will be appreciated that the processes may be implemented in association with the apparatus and systems illustrated and described herein as well as in association with other systems not illustrated.

The above descriptions and illustrations of embodiments of the disclosure, including what is described in the Abstract, is not intended to be exhaustive or to limit the embodiments to the precise forms disclosed. While specific embodiments of, and examples for, the embodiments are described herein for illustrative purposes, various equivalent modifications are possible within the scope of the disclosure, as those skilled in the relevant art will recognize. These modifications can be made to the embodiments in light of the above detailed description.

We claim:

1. A computer implemented method comprising:
receiving a request to create content for a product having a plurality of releases;
determining product features that are associated with each release of the product;
creating product features with attributes and relationships in a database;
describing a business value and technical information for each product feature;
managing relationships from the product features to other product content entities;
managing relationships from the other product content entities to one or more product features;
testing a product feature list including the product features;
setting a status attribute of one or more product features to public; and
releasing the list of the public product features to customer interfaces supporting a plurality of customer use cases using the product features.

2. The computer implemented method of claim 1, wherein the customer use cases include discovery of delta functionality.

3. The computer implemented method of claim 1, further comprising enabling advanced search capabilities within the customer interfaces based on the product feature attributes and relationships to support the customer use cases.

4. The computer implemented method of claim 1, wherein the request to create the product content is received by a development team.

5. The computer implemented method of claim 1, wherein each product feature is determined by the existence of a benefit or business value of the corresponding function of the product.

6. The computer implemented method of claim 1, wherein each product feature includes a link pointing to an implementation artifact contributing to the description in the product feature.

7. The computer implemented method of claim 1, wherein at least one product feature from an older release of the product is enhanced by a new product feature, the new product feature being assigned to the older release and being semantically the same as the product feature being enhanced.

8. The computer implemented method of claim 1, further comprises setting a status of one or more product features to deprecated status, when the functionality described in the product feature is phased out.

9. The computer implemented method of claim 1, wherein each product feature includes product version information, and a determination of the product features that are associated with each release of the product is made based on the product version information.

10. The computer implemented method of claim 9, wherein:
the product features include one or more relationships to other product features; and
the relationships to other product features include requiring another product feature as a prerequisite, superseding another product feature, and contributing to another product feature.

11. A computer implemented method comprising:
creating a plurality of product features with attributes, the attributes of each product feature describing at least one of a business benefit and technical detail provided by a function of a software product;
linking each product features to exactly one version of the software product with which the product feature is released initially;
storing and managing references in one or more of the product features to content entities providing additional data to the product features; and
listing references to one or more product features in an entity using the product features.

12. The computer implemented method of claim 11, further comprises setting a status of one or more product features to deprecated status, when the functionality described in the product feature is phased out.

13. The computer implemented method of claim 11, further comprises extending a product feature by creating a new product feature describing features of the extension and associating the new product feature with the product feature being extended.

14. The computer implemented method of claim 11, further comprises testing the product features to determine if predetermined attributes of the product features are provided in each product feature.

15. The computer implemented method of claim 11, further comprises controlling the visibility of the product feature to customers, wherein the visibility is controlled based on whether the version of the product with which the product feature is associated is released to customers.

16. The computer implemented method of claim 11, further comprises controlling the visibility of the product feature to customers, wherein the visibility is controlled based on customer licensing information.

17. The computer implemented method of claim 11, further comprises generating a report for each version of the product, the report including information on the use of the product features included in each version of the product.

18. The computer implemented method of claim 11, further comprises storing and managing an implementation link in each product feature, the implementation link pointing to an implementation artifact associated with the function described in the product feature.

19. The computer implemented method of claim 11, wherein each product feature is determined by the existence of a benefit or business value of the corresponding function of the product.

20. A non-transitory computer readable medium containing program instructions, wherein execution of the program instructions by one or more processors of a computer system causes one or more processors to carry out the steps of:
receiving a request to create content for a product having a plurality of releases;
determining product features that are associated with each release of the product;
creating product features with attributes and relationships in a database;
describing a business value and technical information for each product feature, the description in each product feature being determined by the existence of a benefit or business value of the corresponding function of the product;
managing relationships from the product features to other product content entities;
managing relationships from the other product content entities to one or more product features;
setting a status of one or more product features to deprecated status, when the functionality described in the product feature is phased out;
storing and managing an implementation link in each product feature, the implementation link pointing to an implementation artifact associated with the function described in the product feature;
testing a product feature list including the product features;
setting a status attribute of one or more product features to public;
releasing the list of the public product features to customer interfaces supporting a plurality of customer use cases using the product features; and
enabling advanced search capabilities within the customer interfaces based on the product feature attributes and relationships to support the customer use cases.
